(19) United States
(12) Patent Application Publication
(10) Pub. No.: US 2008/0120549 A1
(43) Pub. Date: May 22, 2008

(54) System and method for displaying numbered descriptions

(76) Inventors: Ann-Marie Meyers, Flower Mound, TX (US); Philip G. Meyers, Flower Mound, TX (US)

Correspondence Address: Philip G. Meyers;Philip G. Meyers Law Office, Suite 300, 1009 Long Prairie Road, Flower Mound, TX, 75022, US

(21) Appl. No.: 11/602,641

(22) Filed: Nov. 21, 2006

(51) Int. Cl. G06F 3/00

(52) U.S. Cl. 715/719

(57) ABSTRACT

According to a method of the invention, a user can simultaneously display the text and drawings of a document containing a numbered description such as a patent. A computer-implemented system finds a reference number selected by the user/reader in the drawings and displays it in the graphic display, so that the user does not have to hunt for it.

### TECHNICAL FIELD

This invention relates to software applications for displaying documents, particularly documents which contain a narrative description that refers to numbered elements shown in a series of separate drawing figures, such as a patent document.

### BACKGROUND OF THE INVENTION

The U.S. Patent Office has recently made significant progress towards automating the patent search and examination process. The advent of the PAIR system has made it possible for Internet users to browse images from an electronic file wrapper at remote personal computers. The USPTO has also provided a free patent search database which allows searching by keyword and viewing or printing of the patent drawings as successive images using a graphics plugin for a browser such as Internet Explorer. This has made searching and review of hits found in a search vastly easier.

Despite these advances, however, the process of actually reading and understanding a patent or similar numbered description remains difficult. The drawing figures are separate from the detailed description that refers to them. Hence in reading a sentence from the detailed description of a patent or the like, the reader must constantly stop and search the drawing figures visually for the reference number cited in the text. The number may be difficult to find in a long complex patent and there may be several references to it in different drawings views. It may be necessary to see where a part is located from multiple directions in order to understand how it operates, hence the reader may be required to find and study multiple references to the same number before returning to the text narrative once again. This makes reading a detailed description of this nature a slow and tedious process.

Recent emphasis directed towards improving the usability or readability of a book or text work has focused on trying to incorporate multimedia elements. According to U.S. Pat. No. 7,136,819, Nov. 14, 2006, for example, an interactive multimedia book provides hands-on multimedia instruction to the user in response to voiced commands. The book is implemented on a computer system and includes both text and audio/video clips. The interactive multimedia book is accessed by voiced commands and natural language queries as the primary user input. The displayed text is written in a markup language and contains hyperlinks which link the current topic with other related topics. The user may command the book to read the text and, as the text is read by the voice synthesizer, a word which is also a hyperlink will change its attributes upon being spoken. The user will be able to observe or hear this and simply utter the word which is the hyperlink to navigate to the linked topic. This does not however aid the user in linking graphical content to the text.

The present invention is directed towards a system whereby a detailed numbered description is made more readable.

### SUMMARY OF THE INVENTION

According to a method of the invention, a user can simultaneously display the text and drawings of a document containing a numbered description such as a patent. A computer-implemented system finds a reference number selected by the user/reader in the drawings and displays it in the graphic display, so that the user does not have to hunt for it.

According to one aspect of the invention, a computer implemented method is provided for simultaneous display of text and drawings of a document containing a numbered description wherein numbered elements in the text are represented by corresponding numbers in the drawings. Such a method includes the steps of displaying the text of the document in a first video display area, selecting a first numbered element from the text, displaying a first drawing view showing the first numbered element in a second video display area which can be viewed simultaneously with the first video display area by a user selecting the first numbered element, selecting a second numbered element from the text, and displaying a second drawing view showing the selected numbered element in the second video display area. The selecting and displaying steps may be repeated three or more times as needed as the user reads the text in the display area, which will normally be a screen window or frame. The invention further provides a computerized system for carrying out the foregoing method, as discussed in the detailed description that follows.

### BRIEF DESCRIPTION OF THE DRAWINGS

In the accompanying drawings, where like numerals denote like elements:

FIG. 1 is a flow diagram of a method according to the invention;

FIG. 2 is a sample screen display created using a system according to the invention following a search request; and

FIG. 3 is the sample screen display of FIG. 2, following a repeated search request for the next occurrence of the same element.

### DETAILED DESCRIPTION

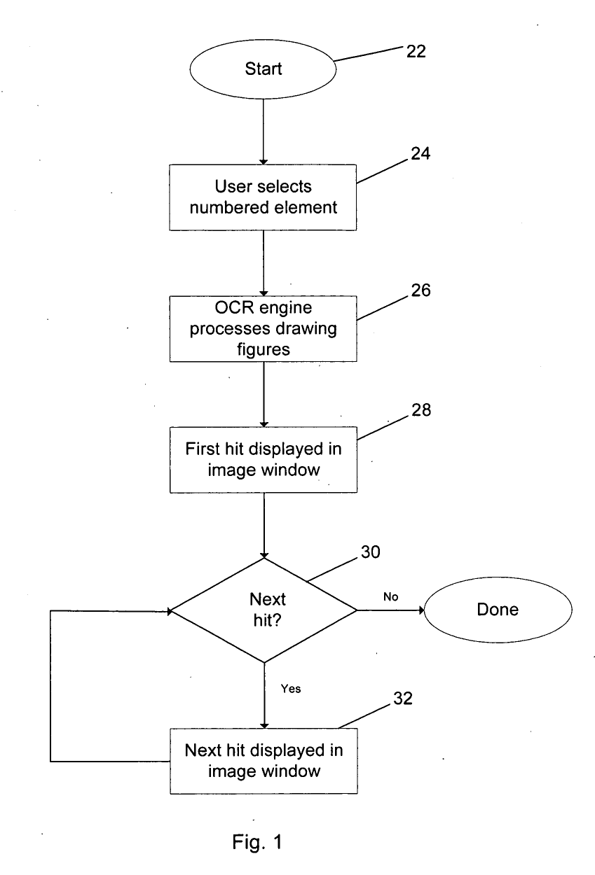

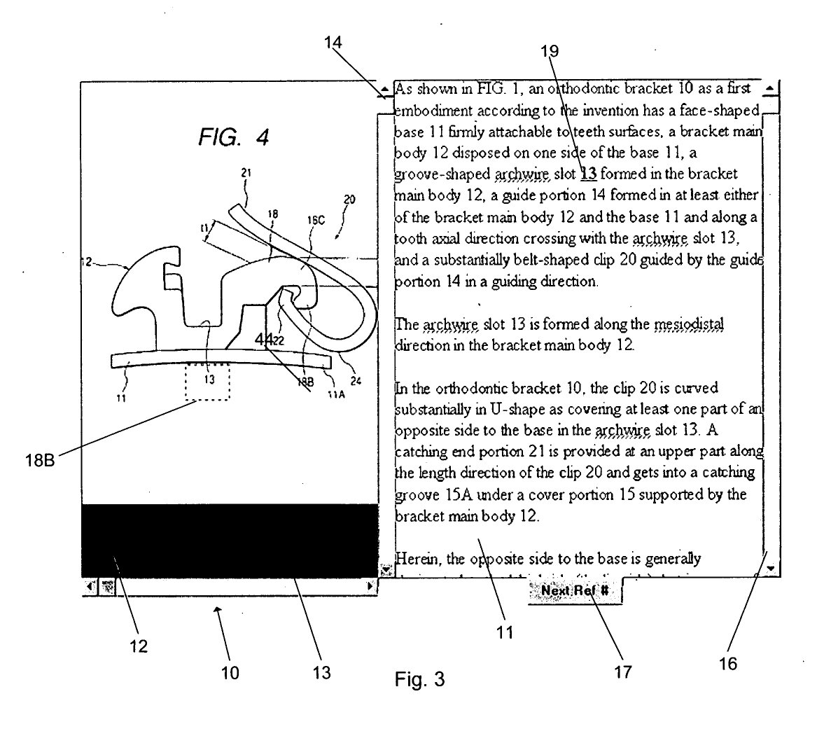

Referring to FIGS. 1 to 3, according to one example of the invention, a user such as a patent examiner or attorney loads patent image data from a remote server through a network such as the Internet to a local computer (e.g., a PC). The patent text is loaded in a text format such as html for display in a text window 11 of a program screen display 10. Image data containing the patent drawing figures is prepared for loading into a separate graphics window 12 that may be present initially with the first figure or patent cover page loaded therein, or only appear next to the text window 11 only when trigger by a user event. Graphics window 12 will generally contain an entire patent drawing page but only show a portion thereof. Horizontal and vertical scrollbars 13, 14 permit the user to shift the displayed portion of the drawing image. A scroll bar 16 permits the user to scroll through the text in window 11. Windows 11, 12 may be resizable to show a greater or less amount of text and drawing.

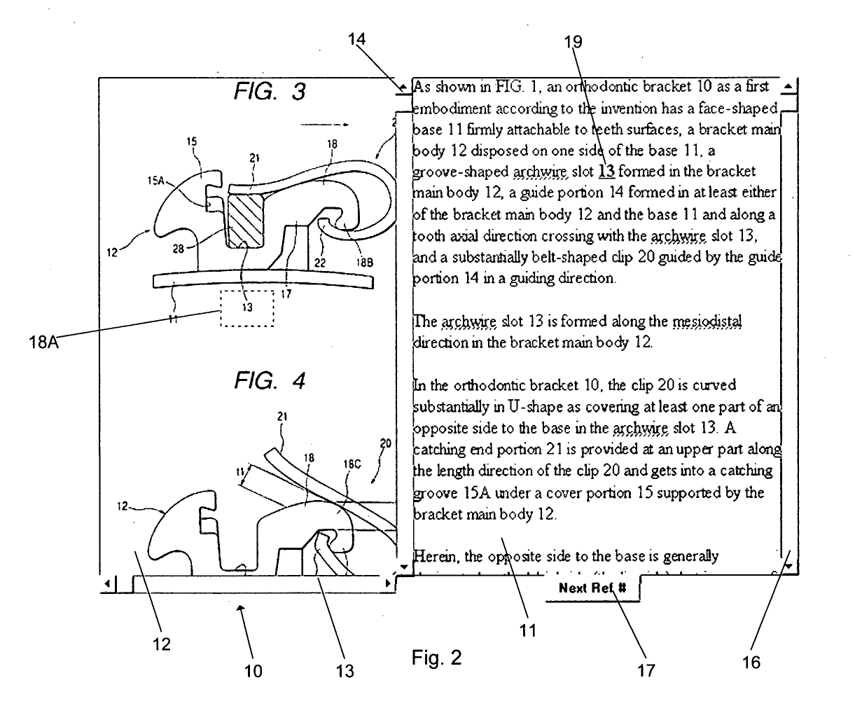

While reading the text the user may want to find where a numbered element or word used in the text appears in the drawings (start step 20). For this purpose the user selects a number or word 19 from the text window and copies it to the Windows clipboard, or the program may capture selected text directly. The user may then give a key command, click and on screen button object or the like to trigger the search process (step 22). An OCR engine then analyzes the drawing figures, starting with the first figure or whichever figure the user has manually paged to in graphics window 12. The OCR engine may start the image analysis process anew each time a request is made (step 26), or may pre-process the drawing figures during loading (step 20) to map where alphanumeric characters appear in each figure. If a match is found, for example the user has selected element 13 which the text calls a “slot 13”, then the image in graphics window 12 is changed so that the first occurrence of the characters “13” appears in the graphics window 12 as shown in FIG. 2 (step 28), optionally center in that window and/or surrounded by highlighting such as a dotted box 18A. This enables the reader to see, without having to put the text aside and search the figures visually, where that numbered element appears. Since the element “13” may share common characters with “113, 213” and the like if such are present, the OCR engine may optionally require spacing in front of and/or behind an image of “13” before a match is made, so that a request for “13” does not return instances of “113” and the like.

If the user wants to look for further references to that numbered element in the figures (decision 30), then if so a command is given to continue (as by a mouse double click or clicking on a screen button control 17, for example) and the system displays the next hit and highlights in a second highlight box 18B. The next hit may be on the same page of the drawings as the first, or may require the program to cycle through successive images. For this purpose the OCR engine can process all of the drawing figures to find all instances when the initial request is made, or can process the image data one request at a time, moving from one figure image to the next as it does so.

An OCR based system such as the foregoing has the advantage that patent text and graphics images as they presently exist can be used without conversion to a special format. However, a number of other means of linking text to graphics to achieve the aim of the present invention are possible. For example, the text portion of the description can be an html document wherein each reference number is hyperlinked to a separate graphics file that is loaded into the graphics window or pop-up window when the link is clicked on. The separate graphics file will likely be a portion of a drawing figure with the selected number at the center of the image. This embodiment requires no special control program and could be implemented as a simple web page, but is labor intense in that the links between the text and the graphics files must be generated in advance.

According to another aspect of the invention, each patent is analyzed in advance by the OCR engine to create a reference table between elements of the detailed description and locations in the drawing. The table could take the form of a series of entries: reference number, number of times referenced in drawing figures (a number from 1 to n), page number of 1st reference, coordinates (x,y) of feature on that page, and so on for occurrences 2 to n for that feature. This eliminates the need to re-OCR each patent each time it is read, the system instead relying on the lookup table to find and display the appropriate portion of a figure in response to each user request.

While the invention has been described with reference to illustrative embodiments, this description is not intended to be construed in a limiting sense. For example, the invention is not limited to patents and could be applied to instruction manuals, computerized parts catalogs and the like. The displays are described as windows or frames on the same screen, or as pop-up windows, but a split screen or separate video screens could be used for display of text and drawings. Various other modifications and combinations of the illustrative embodiments will be apparent to persons skilled in the art upon reference to the description. Such variations and additions are specifically contemplated to be with the scope of the invention. It is intended that the appended claims encompass any such modifications or embodiments.

1. A computer implemented method for simultaneous display of text and drawings of a document containing a numbered description wherein numbered elements in the text are represented by corresponding numbers in the drawings, comprising the steps of:
displaying the text of the document in a first video display area;
selecting a first numbered element from the text;
displaying a first drawing view showing the first numbered element in a second video display area which can be viewed simultaneously with the first video display area by a user selecting the first numbered element;
selecting a second numbered element from the text; and
displaying a second drawing view showing the selected numbered element in the second video display area.

2. The method of claim 1, further comprising repeating the selecting and displaying steps three or more times in response to user selections.

3. The method of claim 2, where the user selections are made by a user with an input deice, which user is viewing the first and second display areas.

4. The method of claim 1, further comprising selecting the same first numbered element from the text two or more times in succession, and displaying a series of different drawing views each showing the first numbered element in the second video display area.

5. A computer implemented system for simultaneous display of text and drawings of a document containing a numbered description wherein numbered elements in the text are represented by corresponding numbers in the drawings, comprising:
a computer having a memory;
image viewing control software loaded into the computer memory;
a first video display displaying the text of the document;
means permitting a user to select a first numbered element from the text in the first display;
a second video display suitable for showing a graphical image corresponding to the first numbered element in a second video display area which can be viewed simultaneously with the first video display area by the user;
wherein the control software displays the text of the document in a first video display area, allows a user to select a first numbered element from the text using an input device, displays a first drawing view showing the first numbered element in the second video display area which can be viewed simultaneously with the first video display area, allows a user to select a second numbered element from the text using the input device, and displays a second drawing view showing the second numbered element in the second video display area.
